(19) United States
(12) Patent Application Publication
(10) Pub. No.: US 2013/0154555 A1
(43) Pub. Date: Jun. 20, 2013

(54) SLIDING WIRELESS CHARGING TRAY FOR INDUCTIVE CHARGING OF ELECTRONIC DEVICES

(71) Applicant: Toyoda Gosei Co. Ltd., Haruhi-Nishinomachi (JP)

(72) Inventors: Thomas Anthony Miller, Royal Oak, MI (US); Paresh Rana, Clawson, MI (US); Jeremiah Phillip Nienhuis, W. Bloomfield, MI (US)

(73) Assignee: Toyoda Gosei Co. Ltd., Haruhi-Nishinomachi (JP)

(21) Appl. No.: 13/686,981

(22) Filed: Nov. 28, 2012

Related U.S. Application Data
(60) Provisional application No. 61/564,006, filed on Nov. 28, 2011.

(51) Int. Cl. H02J 7/00

(52) U.S. Cl. CPC H02J 7/0042
USPC 320/108

(57) ABSTRACT

The present invention relates to a sliding tray comprising: a base panel; a top panel at least partially offset from the base panel, creating a local pocket therebetween; a battery recharging system disposed within the local pocket and adapted to provide one or more electromagnetic fields capable of transferring an electrical charge to a properly equipped portable electrical device; an electrical connection feature adapted to electrically connect the battery recharging system to a host; a tray sliding feature disposed on the base panel, the top panel, or both adapted to mate with a bin sliding feature of a bin and allowing for the sliding tray to move relative to the bin.

### FIELD OF THE INVENTION

The present invention relates generally to a sliding recharging or connection tray for portable electronic devices and to assemblies containing such trays. The sliding trays and assemblies are especially useful in vehicles.

### BACKGROUND OF THE INVENTION

Portable electronic devices are common place and many people carry one or more. Portable electronic devices require recharging and often need to be placed in communication with another system which uses and/or generates information. In order to recharge or to allow a portable electronic device to communicate with other information generating or using systems direct connections utilizing one or more specially designed cords may be generally required. Each device uses a different cord and may use different cords for recharging and for communicating with information using or generating systems. In many locations, such as a vehicle, the presence of the cords is unsightly and may cause safety problems, because the cords can interfere with the function of other devices or controls of the host. Portable electronic devices also have connections for direct connection to other information using or generating systems and each portable device generally has a unique connection system. Recently systems for wirelessly charging the batteries of portable electric devices have become available. Such systems utilize a device which generates an electromagnetic field. The portable electronic device requires a device which when located in close proximity to the electromagnetic field can transform the energy of the electromagnetic field into a charge to recharge the battery of the portable electronic device. Examples of such systems are disclosed in Baarman et. al. US Patent Publication 2008/0001572; Baarman et. al US Patent Publication 2009/0212637; Baarman et. al. US 2009/0106567; Arai US Patent Publication 2008/0122297, Thorsell et al. US 2011/0156637 and Azancot et. al. WO 2009/040807 all incorporated herein by reference.

The problems presented to the user of portable electronic devices in a host system, such as a vehicle, are many. One problem is the need to recharge portable electronic devices using unique cords for each device. Another problem is that such devices have unique direct connection systems which prevent the use of a universal connection system in a host system. Another problem is the need for one or more cords which can be strung in inconvenient places or can present safety problems due to their location, for instance in or around vehicle shift controls or other vehicle controls. Another problem associated with the use of portable electronic devices is the need for the user to view one or more displays associated with the portable electronic devices and the lack of a place for locating the portable electronic devices to facilitate easy viewing of the displays, for instance in a vehicle. Another problem is that given the relatively limited package space that can be available, especially in a vehicle, and a desire to have a sliding tray to maximize the usage of the limited space while providing the above mentioned functionality as well as a place for storage and/or other conductivity interfaces (e.g. power points, USB ports, and the like).

What is needed is a system which allows a portable electronic device to be charged and/or connected to a hosts power system or information use or generation system without the need for a separate power cord. What is further needed is such a system which allows an efficient use of space, thus allowing for the packaging of a sliding tray. What is further needed is such as system that allows for a bin assembly that contains the sliding tray with an integral power charging system, along with a storage area, and other conductivity interface devices.

### SUMMARY OF THE INVENTION

The present invention meets one or more of the above needs and is a sliding tray comprising: a) a base panel; b) a top panel at least partially offset from the base panel, creating a local pocket therebetween; c) a battery recharging system disposed within the local pocket and adapted to provide one or more electromagnetic fields capable of transferring an electrical charge to a properly equipped portable electrical device; d) an electrical connection feature adapted to electrically connect the battery recharging system to a host; e) a tray sliding feature disposed on the base panel, the top panel, or both adapted to mate with a bin sliding feature of a bin and allowing for the sliding tray to move relative to the bin. The battery recharging system has a thickness such that it fits into the local pocket and the local pocket has a maximum internal sectional thickness of no greater than about 25 mm, more preferably no great than about 15 mm, but obviously greater than 0 mm. The sliding tray is adapted for use in a host system which supplies power to the tray or which transfers data between the portable electronic device and the system of the host. In a preferred embodiment, the host system is or is utilized in a vehicle.

In another embodiment, the invention is an article comprising: a sliding tray assembly and a bin assembly; the sliding tray assembly comprising: a) a base panel; b) a top panel at least partially offset from the base panel, creating a local pocket therebetween; c) a battery recharging system disposed within the local pocket and adapted to provide one or more electromagnetic fields capable of transferring an electrical charge to a properly equipped portable electrical device; d) an electrical connection feature adapted to electrically connect the battery recharging system to a host; and e) one or more tray sliding features disposed on the base panel, the top panel, or both; the bin assembly comprising: an outer shell portion creating a bin pocket therebetween and including one or more open areas; and one or more bin sliding features adapted to mate with the one or more tray sliding features and allowing for the sliding tray to move to and from the one or more open areas.

The sliding tray and bin assembly of the invention allows the charging and/or connection of a portable electronic system in or to a host, such as a vehicle, without the need for unique cords. The sliding tray and bin allows a user to store and view one or more portable electronic devices in a convenient and safe manner. The sliding tray and assembly of the invention allow the user to utilize portable electronic devices in a safer manner, and provides a storage area and potentially other conductivity interface devices.

### DESCRIPTION OF THE DRAWINGS

FIG. 1A is a view of a tray of a free standing tray of the invention.

FIG. 1B is a cut-away view of the tray of FIG. 1A along line B-B.

FIG. 1C is a view of a tray with integrated into a console.

FIG. 2A is a view of another embodiment of the tray of the invention in a closed position.

FIG. 2B is a cut away view of the tray of 2A.

FIG. 3A is a view of a closed tray of the invention having a through hole and a battery recharging system protruding through the through hole.

FIG. 3B is a cutaway view of the tray of 3A.

### DETAILED DESCRIPTION

The invention relates to a sliding tray useful in recharging and connecting portable electronic devices to a host. Host as used herein means any system wherein a portable electronic device can be used or interacts to share information, including those locations where the trays and assemblies of the invention can be utilized in conjunction with a portable electronic device. Such hosts can be a vehicle or a system which uses or generates information, such as an entertainment system or a computer system. Preferably the host is a vehicle.

In one embodiment, the invention is a sliding tray which is adapted to perform one or more of the following functions: recharge a portable electronic device either wirelessly or through a dedicated connection; store a portable electronic device; support the portable electronic device in a manner such that a display on the device is easily visible to a user; secure the portable electronic device in a desired location; eliminate the need for one or more charging cords or connection cords for portable electronic devices; facilitate the communication of a portable electronic device with a system that uses or generates data or information; and improve the safety of the use of a portable electronic device in a vehicle. A system that uses of generates information is any system that takes the input of information and data to generate an output or to adjust the performance of a system. Such systems include computer systems, including on board controllers found in vehicles; audio and video systems; navigation systems; wireless controllers adapted to remotely control systems, such as garage door openers, lights, access points of buildings and the like.

The sliding tray of the invention comprises at least two or more parts, a panel structure (with an internal pocket) which functions as a base upon which the tray is assembled and a battery recharging system. In a preferred embodiment, the panel structure includes a base panel and a top panel, wherein the top panel is off-set from the base panel to create a local pocket.

Generally, the base functions to support the rest of the tray and potentially to communicate (electrically and/or physically) with any system or part into which the sliding tray is incorporated or will be incorporated. The base panel may include an electrical connection feature adapted to a battery recharging system and may include all or part of a tray sliding feature. In a preferred embodiment, the base panel is in the shape of a square or rectangle and more preferably is substantially flat.

It is contemplated that top and bottom panels can be held together by any means which can hold the parts together during normal use. The means for holding the two parts together preferably include snap fits, screws or a combination thereof. In a preferred embodiment, the two parts of the tray are held together in a manner such that they can be separated to allow access to the internal parts (e.g. battery charging system) to facilitate repair or replacement of internal parts. Parts of the tray which do not need to be visible to the user or which need to be protected in some manner from the environment can be mounted on the base panel along the side that is internal to the tray structure.

The sliding tray further has one or more contacts adapted to facilitate contact of the tray with the electrical system or another system of the host. The contacts can be located at any location of the tray which allows them to come into contact with appropriate contacts of the host. The contacts on the tray can be in any form which allows transmission or electrical energy or system data between the host and the portable electronic device. The contacts can be located on the tray in any location which allows the contacts to come into contact with the host electrical system, including on one or more of the back or one of the sides of the protrusions of the tray. In one preferred embodiment the electrical contacts are located on the protrusions of the base panel wherein the electrical contacts are located such that when the tray is slid into grooves of a bin assembly the electrical contacts are in contact with electrical contacts in the grooves. The electrical contacts in the grooves are further connected to a source of power in the host. The contacts of the groove and the contacts of the tray cooperate to transmit electricity from the host to the tray and ultimately to the portable electronic device. The electricity can be used to run the portable electronic device or to charge the battery contained in the portable electronic device. The contacts located on the base can be any contacts which are capable of transmitting electricity and which can be arranged to protrude from the protrusions at the edge of the base panel. The contacts should protrude enough to contact the contacts in the groove of the assembly. Alternatively the electrical contacts can be located in indentations located on the base of the panel and the contacts of the host can protrude from the host in a manner to contact the electrical contacts in the tray. Preferably the contacts are comprised of a conductive metal, such as copper. Preferably the electrical contacts are metal strips which are attached to one or both of the sides or the back of the base panel. Preferably the contacts are located on one or both of the protrusions on the base panel. Preferably the metal strips are bent in a manner that the center of the strips protrude from the side of the base panel. In a preferred embodiment the electrical contacts are located in depressions along the side of the protrusions in the base panel and are arranged such that a portion of the electrical contacts protrude from the edge of the base panel so as to allow them to come into contact with metal contacts located in grooves of the panels of assembly of the invention. In a preferred embodiment, the electrical contacts are located toward the rear of the base panel to allow the tray to be pulled out from the assembly and still remain in contact with the conductive metal contacts of the grooves of the assembly. In the embodiment wherein the contacts are adapted to connect the portable electronic device to a system of the host, the contacts can be arranged as described hereinbefore. Alternatively, the contacts can be either a plug or a plug receptacle which mates with a plug or plug receptacle in the host. In one embodiment the tray can contain prongs on the back of the tray which mates with a plug in the host. Such prongs can be fixed to the back of the tray or be at the end of a flexible wire system which is connected to the sliding tray, preferably in the back.

The sliding tray further comprises a battery recharging system or a connection for a portable electronic device adapted to connect the portable electronic device to the power system of the host, to communicate with an information using or generating system of the host, or both. The battery recharging system can be any recharging system which functions to recharge the batteries of a portable electronic device. Such systems are known to the skilled artisan, but not one that typically is sufficiently thin to fit inside the tray's internal pocket (e.g. the pocket being no greater than about 25 mm, more preferably no greater than about 15 mm), particularly in the case of an induction charging system. In the embodiment wherein the tray contains a connection to the power system of the host, the battery of the portable electronic device will generally charge using the recharging system integrated into the portable electronic device. In a preferred embodiment, the battery recharging system uses an electromagnetic field to recharge a properly equipped portable electronic device. Examples of such recharging systems are available from Powermat and licensees of Fulton Innovation Inc. and include those systems disclosed in Baarman et. al. US Patent Publication 2008/0001572; Baarman et. al US Patent Publication 2009/0212637; Baarman et. al. US 2009/0106567 and Arai US Patent Publication 2008/0122297, Thorsell et al. US 2011/0156637 and Azancot et. al. WO 2009/040807 all incorporated herein by reference. In a preferred embodiment, the battery recharging system comprises i) a control module connected to the connecting means; ii) a means for converting electrical energy to an electromagnetic field, iii) a second connecting means adapted to connect the control module with the means for converting electrical energy to an electromagnetic field; iv) a shield located between the control module and the means for converting electrical energy to an electromagnetic field; and v) a securing means for holding the means for converting electrical energy to an electromagnetic field on or near the non-visible side of the top panel. The control module functions to control the flow of electricity to the means for converting electricity to an electromagnetic field. Typically the control module is connected to the electrical contacts of the tray and to the means for converting electricity to an electromagnetic field. Typically the control module contains a circuit board and/or a computer chip adapted to control the function of the battery recharging system. The control module is preferably located within the tray. It can be located in any place within the tray. Preferably, the control module is located on the base panel. In a preferred embodiment, the control module is affixed to the base panel. The control module may be affixed to the base panel to protect it from being damaged as a result of moving around within the tray. The battery recharging system contains a second connecting means adapted to connect the control module with the means for converting electrical energy to an electromagnetic field. Generally, the second connecting means can be any means which functions to conduct electricity and/or information between the control module and the means for converting electrical energy to an electromagnetic field. In a preferred embodiment it is two or more wires, a wire harness pigtail, and the like. Preferably, the second connecting means is a pair of wires which conduct electricity. The means for converting electricity to an electromagnetic field can be any means which converts electricity to an electromagnetic field wherein the electromagnetic field is capable of providing electricity to a properly equipped portable electronic device capable of converting the electromagnetic energy to electricity to charge the battery of the portable electronic device. In a preferred embodiment, the means for converting electrical energy to an electromagnetic field comprises a circular coil of conductive wire. Such coil of wire is preferably located near or adjacent to the inside surface (non-visible surface) of the top panel. The circumference, thickness of the wires and the number of wires in the coil are selected in a manner such that the desired electromagnetic field is produced when connected to a source of electricity. The battery recharging system further comprises a securing means for holding the means for converting electrical energy to an electromagnetic field on or near the non-visible side of the top panel. Such securing means can comprise any method of securing the means for converting electrical energy to an electromagnetic field in the desired location. Such securing means can comprise a panel affixed to the inside of the top panel, springs, elastic bands, one or more armatures, wherein if there are more than one they are interconnected, and the like. In the embodiment wherein the securing means is one or more armatures, such armatures can be arranged as described below. The armatures are rotatably attached to a bridge component and the bridge component is attached to a panel of the tray. The means for converting electrical energy to an electromagnetic field is secured to the end of the lower arm This configuration allows for the movement of the means for converting electrical energy to an electromagnetic field almost anywhere (x and y movement) within the span of the interconnected armatures, when the means for converting electrical energy to an electromagnetic is subjected to a tangential force. It is also contemplated that the armatures may include geometric features (e.g. tabs, projections, or the like) that may function to limit the relative movement of a given armature (e.g. to less than 360 degrees rotation). In a preferred embodiment, the means for converting electrical energy to an electromagnetic field is located substantially parallel to the plane of the top panel. The securing means can be free floating or can be fixed in place once the securing means is located in the desired location. The means for fixing the securing means in place are well known to the skilled artisan. The shield located between the control module and the means for converting electrical energy to an electromagnetic field functions to shield the control module from the electromagnetic field generated by the means for converting electrical energy to an electromagnetic field. The electromagnetic field can interfere in the function of the control module. The shield is located between the control module and the means for converting electrical energy to an electromagnetic field. The shield can be located adjacent to the control module or the means for converting electrical energy to an electromagnetic field. The shield can be fabricated from any material that does not allow electromagnetic radiation to pass through the shield or allows only an amount of electromagnetic radiation to pass through the shield that does not interfere in the functioning of the control module. The shield can be fabricated from iron containing materials, such as steel, and the like. In one embodiment where the means for holding the means for converting electrical energy to an electromagnetic field on or near the non-visible side of the top panel is fabricated from a material that does not transmit electromagnetic or insignificant amounts of electromagnetic radiation (that amount which does not interfere in the functioning of the control module) such means can also serve as the shield. The shield can be of a size such that the control module is protected from electromagnetic radiation. In a preferred embodiment the shield is affixed to the control module between the control module and the means for holding the means for converting electrical energy to an electromagnetic field near the top panel.

The bin assembly of the invention can contain one or more connections adapted to connect one or more portable electronic devices to the host. This is particularly advantageous where the host is a vehicle. The connections can be adapted to allow the portable device to connect directly to the power supply of the host, to exchange information or data with a system of the host which uses or generates information. The connection can be any know connection used with portable electronic devices. Due to the variety of connection systems presently utilized with portable electronic devices, the connection may need to be specific to the particular portable electronic device. It is contemplated that manufacturers of devices or accessories for such devices may provide trays with connections specifically adapted for use with particular devices. Examples of such connections include Apple IPOD jacks, satellite radio jack and the like. In another embodiment, a standard connection which is used in a variety of devices may be used for the tray. Such standard connections include USB connection ports, standardized power jacks for cell phones, mini USB port, audio input jacks and the like. In one embodiment the connection may include a docking jack which communicates with the power supply system of the host, such as the power supply system of the vehicle.

In another embodiment the tray can comprise a module adapted to function as a data exchange system. A data exchange system is a system for transferring data or information between different systems which generate or use data or information. The data exchange module can be directly connected to the portable electronic device through a connection as described hereinbefore or can be connected wirelessly. In the embodiment wherein the data exchange module is connected wirelessly to the portable electronic device, the module can be located in the internal part of the tray, or else somewhere in the bin assembly. The data exchange module can communicate wirelessly with other information generation of using systems of the host. Alternatively, the data exchange module can have a direct connection to the host. In the embodiment wherein the host is a vehicle, the data exchange module can be directly connected to the wire harness of the vehicle or connected by pigtail, RCA cable, a USB wire, firewire, HDMI cable, audio input cable and the like. Where the data exchange module communicates wirelessly with the portable electronic device and other information generating or using systems, any known wireless data communication system may be utilized including blue tooth systems, “RF (radio frequency) systems, WIFI system, and the like.

In another embodiment, the invention is a bin assembly including the sliding tray of the invention. Such a bin assembly comprises an outer shell portion creating a bin pocket therebetween and including one or more open areas; and one or more bin sliding features adapted to mate with the one or more tray sliding features and allowing for the sliding tray to move to and from the one or more open areas. It is contemplated that the sliding tray can move (e.g. slide via the sliding features of the tray, the bin, or both) relative to the bin, moving back and forth from a stowed and a deployed position (and potentially anywhere in-between). It is contemplated that when the sliding tray in the stowed position, the contents of the tray would be at least partially hidden from view, if not completely hidden. It is also contemplated that in the stowed position, there would be access to one of more (storage areas) stowage bins and/or conductivity interface devices.

The bin assembly can be adapted for use in any host system as described hereinbefore. The bin assembly can be an entertainment system, a computer system or a component thereof. Where the host is a vehicle, the assembly can be part of an instrument panel, a floor mounted counsel, a seat structure or an overhead mounted console. The overhead mounted counsel can be integrated into the headliner of a vehicle.

The trays and bin assemblies of the invention can be used with any portable electronic device which can be recharged, needs electricity to function or which can be connected to other information generating or using systems of a host. Examples of such portable electronic devices include cell phones, personal data assistants, portable entertainment devices such as Apple's IPOD portable entertainment devices and Zune portable entertainment devices, portable navigation systems and radar detectors. In this application properly equipped portable electronic devices are referenced. Properly equipped portable electronic devices refer to such devices which have the necessary equipment to work with the trays of the invention. The tray and the portable electronic devices need to be matched as to functionality. For instance if the portable electronic device requires a connection to the host appropriate matching connections are required in the portable electronic device and in the tray. If the portable electronic devices are an IPOD personal entertainment system, the tray needs to have a docking jack which fits the IPOD personal entertainment system. In another embodiment, wherein the tray contains a wireless battery recharging system, the portable electronic device requires matching equipment adapted to convert the electromagnetic field into a form of electricity capable of recharging the battery. In the embodiment wherein the tray contains a coil of wire with generates an electromagnetic field, the portable electronic device may include another wire coil capable of translating the electromagnetic field from the coil located in the tray to electricity capable of recharging the battery of the portable electronic device. In use the portable electronic device needs to be located in the proper position such that the two wire coils can function to transfer energy. In a preferred embodiment both coils have a magnet located in the center of the coils, this allows a user to align the coil of the portable electronic devices with the coil of the tray. The user can move the portable electronic device about on the tray until the magnets align. Generally, the user can feel when they are aligned.

The following description of the figures is provided to aid in an understanding of the claimed invention. The description is not meant to limit the scope of the claims to which the inventors are entitled.

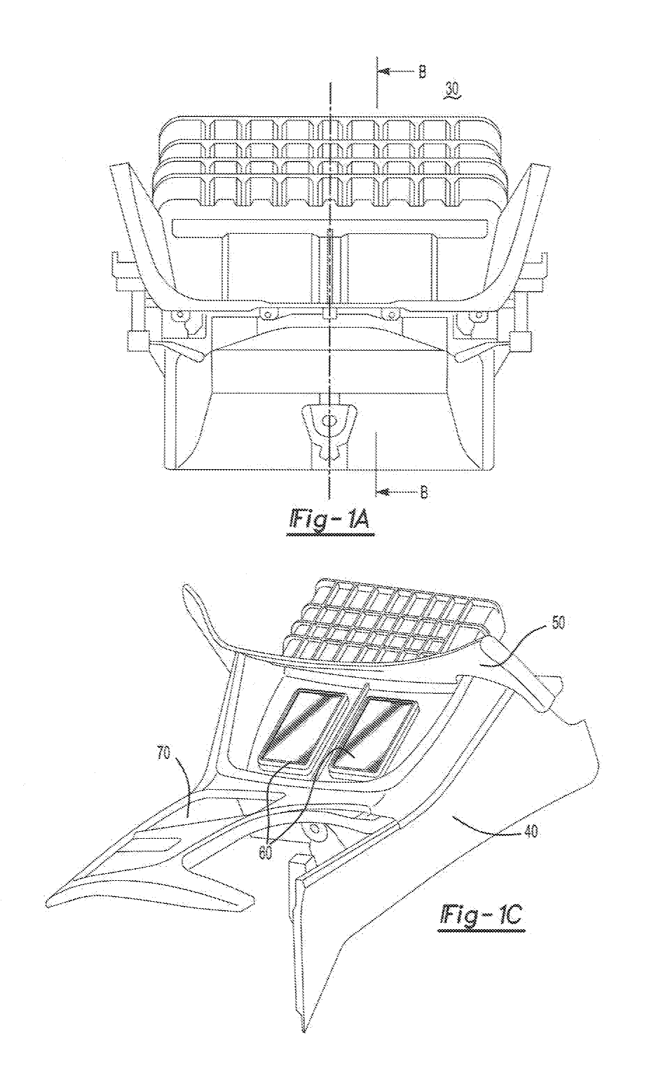

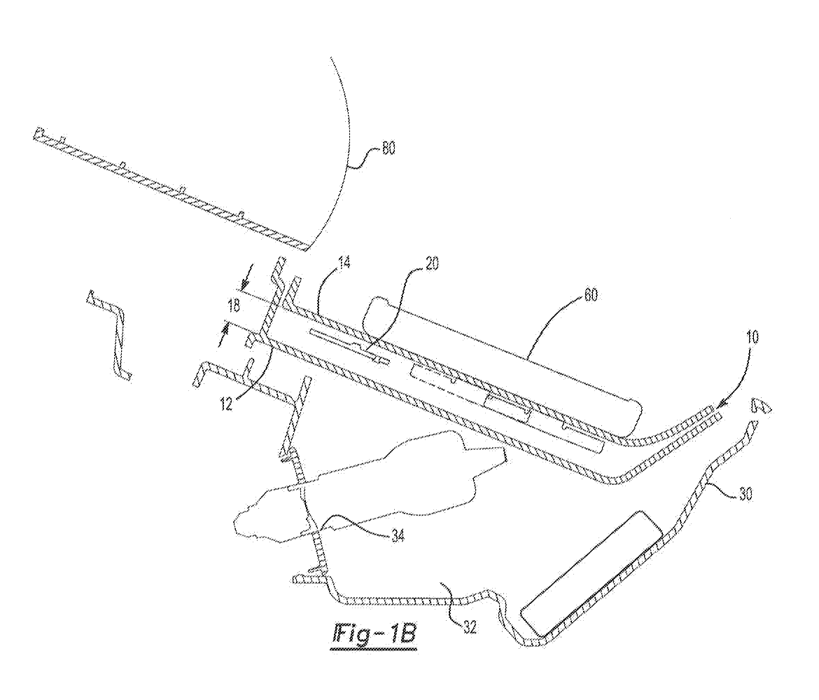

FIGS. 1A-C shows a first illustrative example of the tray and the tray/bin assembly, wherein the sliding tray is in the “deployed” position. The sliding tray 10 shown has a base panel 12, an opposing top panel 14, a pocket 16 therebetween with a section thickness 18. Also, included in the sliding tray 10 is a battery recharging system 20 (which could include a power conditioner component and/or a data exchange system, e.g. wireless charging coil and wireless charging circuit board). The bin assembly 30 is shown, both as a free standing piece (FIG. 1a) and in-situ as part of a vehicle console 40 and instrument panel 50. In a section view (FIG. 1B), the bin storage area 32 and one conductivity interface device 34 (in this case a power point with car adapter plug installed) can be seen. Additionally, a couple of exemplary user devices 60 (e.g. phones) can be seen. Also shown is the vehicle shifter area 70.

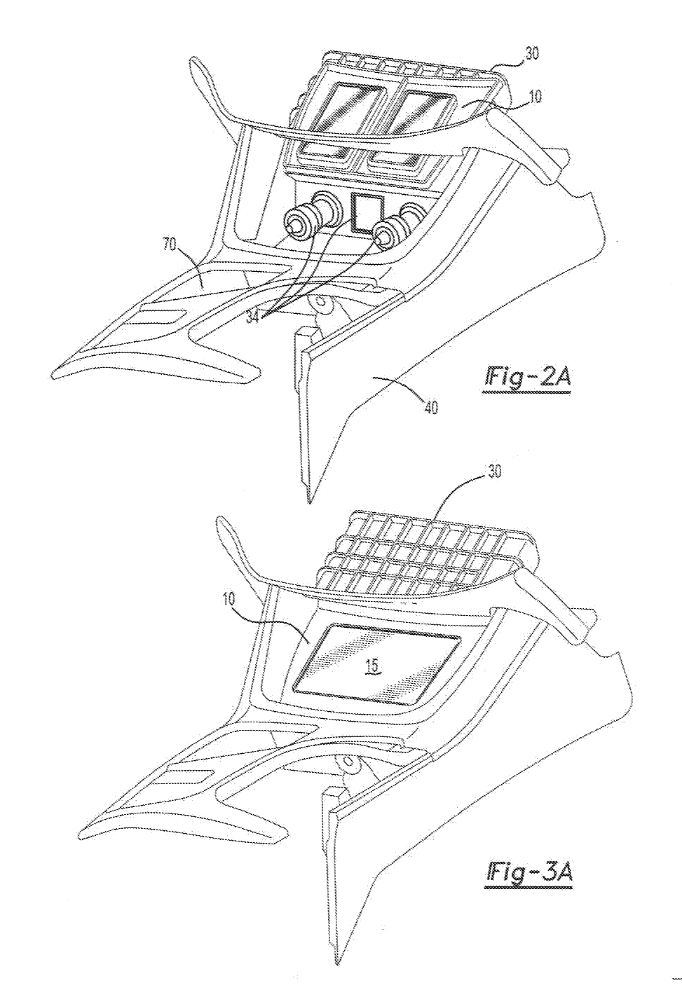

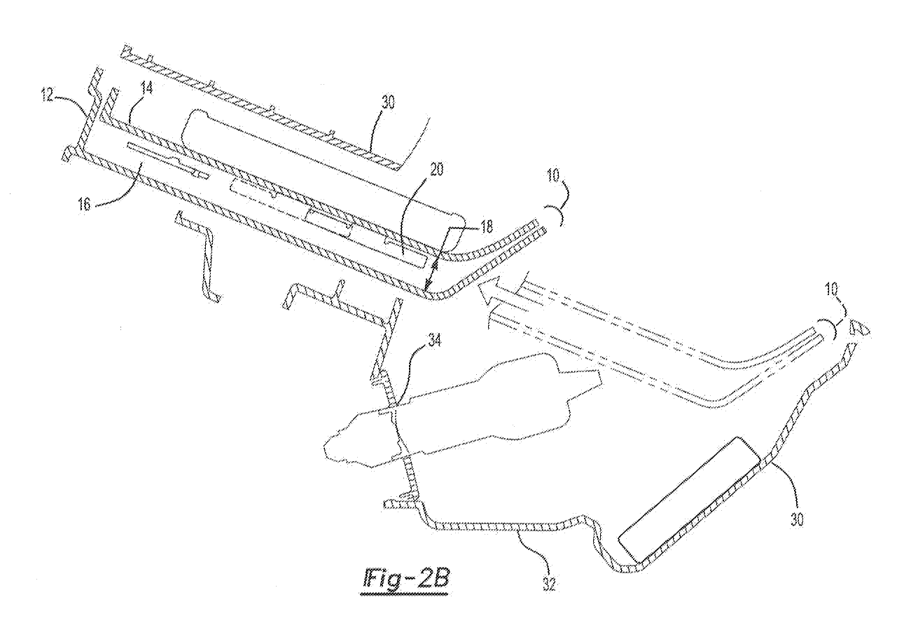

FIGS. 2A-C illustrates the first illustrative example as described above with the sliding tray in a stored position, that is the wireless charging tray 10 is retracted for access to the storage bin 32.

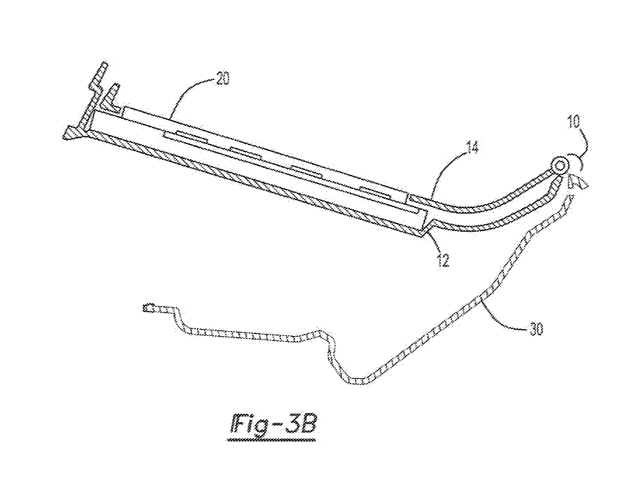

FIGS. 3A-B shows a second illustrative example, wherein the top panel 14 includes a through-hole 15 and the battery recharging system 20 protrudes at least partially through the holes 15. The wireless charging coil 20 is in an adjusted position, and may be adjusted for different phone dimensions.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. This application claims priority from U.S. Provisional Application Ser. No. 61/564,006 filed Nov. 28, 2012, incorporated herein by reference.

What is claimed is:

1. A sliding tray comprising:
a) a base panel;
b) a top panel at least partially offset from the base panel, creating a local pocket therebetween;
c) a battery recharging system disposed within the local pocket and adapted to provide one or more electromagnetic fields capable of transferring an electrical charge to a properly equipped portable electrical device;
d) an electrical connection feature adapted to electrically connect the battery recharging system to a host;
e) a tray sliding feature disposed on the base panel, the top panel, or both adapted to mate with a bin sliding feature of a bin and allowing for the sliding tray to move relative to the bin.

2. The sliding tray according to claim 1, wherein the battery recharging system has a thickness such that it fits into the local pocket and the local pocket has a maximum internal sectional thickness of no greater than 25 mm.

3. The sliding tray according to claim 1, wherein the battery recharging system has a thickness such that it fits into the local pocket and the local pocket has a maximum internal sectional thickness of no greater than 15 mm.

4. The sliding tray according to claim 1, wherein the battery recharging system further comprises a power conditioner.

5. The sliding tray according to claim 1, wherein the top panel includes one or more through holes adapted to receive one or more portions of the battery recharging system.

6. The sliding tray according to claim 1, wherein the sliding tray includes a power conditioner component, a data exchange system, or both.

7. An article comprising:
a sliding tray assembly and a bin assembly;
the sliding tray assembly comprising:
a) a base panel;
b) a top panel at least partially offset from the base panel, creating a local pocket therebetween;
c) a battery recharging system disposed within the local pocket and adapted to provide one or more electromagnetic fields capable of transferring an electrical charge to a properly equipped portable electrical device;
d) an electrical connection feature adapted to electrically connect the battery recharging system to a host; and
e) one or more tray sliding features disposed on the base panel, the top panel, or both;
the bin assembly comprising:
an outer shell portion creating a bin pocket therebetween and including one or more open areas; and
one or more bin sliding features adapted to mate with the one or more tray sliding features and allowing for the sliding tray to move to and from the one or more open areas.

8. The article according to claim 7 wherein the bin assembly is integrated into a vehicle.

9. The article according to claim 7 wherein the bin assembly is integrated into a vehicle instrument panel or a vehicle console.

10. The article according to claim 7 wherein the bin assembly is integrated into a vehicle console which is mounted on the floor of the vehicle or mounted to the headliner of a vehicle.

11. The article according to claim 7, wherein the battery recharging system has a thickness such that it fits into the local pocket and the local pocket has a maximum internal sectional thickness of no greater than 25 mm.

12. The article according to claim 7, wherein the battery recharging system has a thickness such that it fits into the local pocket and the local pocket has a maximum internal sectional thickness of no greater than 15 mm.

13. The article according to claim 7, wherein the battery recharging system further comprises a power conditioner.

14. The article according to claim 7, wherein the top panel includes one or more through holes adapted to receive one or more portions of the battery recharging system.

15. The article according to claim 7, wherein the sliding tray, the bin assembly, or both include a power conditioner component, a data exchange system, or both.
